(19) United States
(12) Patent Application Publication
(10) Pub. No.: US 2019/0302745 A1
(43) Pub. Date: Oct. 3, 2019

(54) FACILITY OPERATION ANALYSIS DEVICE

(71) Applicant: HONDA MOTOR CO., LTD., Tokyo (JP)

(72) Inventor: Takumi Shiraishi, Hagagun (JP)

(21) Appl. No.: 16/367,292

(22) Filed: Mar. 28, 2019

(30) Foreign Application Priority Data
Mar. 29, 2018 (JP) 2018-063442

(51) Int. Cl. G05B 19/418; G01D 9/00

(52) U.S. Cl. CPC G05B 19/41835; G01D 9/005; G05B 2219/50391; G05B 2219/36038; G05B 2219/34273

(57) ABSTRACT

In a facility operation analysis device configured to continuously grasp the extent of change (the amount of change) over time of actuators constituting a manufacturing facility, when displaying a result of evaluation on a display device, an evaluating portion compares a measured amount of change with thresholds of the amount of change that are set within a normal range where the manufacturing facility is not stopped, and displays the result of evaluation in which the measured amount of change is ranked.

### CROSS-REFERENCE TO RELATED APPLICATION

This application is based upon and claims the benefit of priority from Japanese Patent Application No. 2018-063442 filed on Mar. 29, 2018, the contents of which are incorporated herein by reference.

### BACKGROUND OF THE INVENTION

### Field of the Invention

The present invention relates to a facility operation analysis device for analyzing execution data about actuators of a facility including a plurality of actuators whose operations are executed based on operation plan data.

### Description of the Related Art

For example, Japanese laid-Open Patent Publication No. 2017-045141 (hereinafter referred to as JPA 2017-045141) discloses a facility operation analysis device that automatically generates a timing chart (operation plan chart) of actuators of a manufacturing facility (a production facility) based on an operation plan provided as input, and a timing chart (executed operating state chart) about the results of execution of the actuators, where the timing charts are displayed in a superimposed manner on a display portion (see FIG. 4 of JPA 2017-045141).

### SUMMARY OF THE INVENTION

With the facility operation analysis device disclosed in JPA 2017-045141, an operation plan chart and an executed operating state chart are automatically generated and displayed in a superimposed manner on a display portion. This saves time and effort of measuring operating time with a stopwatch etc., creating timing charts, and so forth, and allows the manufacturing facility to be periodically and easily checked to see whether it is operating normally.

In the field of such a manufacturing facility having actuators, there is a demand to grasp operating conditions of the facility having actuators not periodically but continuously. Also, there is a demand to instantaneously grasp the extent of changes over time if any. However, the technique described in JPA 2017-045141 cited above (the technique of displaying an operation plan chart and an executed operating state chart in a superimposed manner) cannot meet such demands and there is yet room for improvement.

The present invention has been made considering such problems, and an object of the present invention is to provide a facility operation analysis device that makes it possible to continuously grasp the extents of changes (the amounts of changes) of the actuators constituting the facility.

A facility operation analysis device according to an aspect of the present invention is configured to analyze a result of execution obtained when operations of a plurality of actuators constituting a facility are executed based on operation plan data.

The facility operation analysis device includes:

an execution data measuring portion configured to obtain execution data when the operations of the plurality of actuators are executed;

an amount-of-change measuring portion configured to measure the amount of change of the obtained execution data from reference data; and

an evaluating portion configured to evaluate the measured amount of change and output a result of the evaluation.

When the evaluating portion outputs the result of evaluation, the evaluating portion compares the measured amount of change with a threshold of the amount of change that is set for each of the plurality of actuators within a normal range in which the facility is not stopped, and outputs the result of the evaluation in which the measured amount of change is ranked.

According to the present invention, it is possible to continuously monitor the facility within a normal range in which the facility is not stopped, so that inspection and investigation of the facility can be performed suitably, and it is also possible to continuously grasp the extent of change (the amount of change) of the actuators forming the facility. Furthermore, since the evaluation result is outputted in which the amount of change of each actuator is ranked according to the threshold, human time for judging significance of the change of each of the plurality of actuators is reduced and uniformity of the judgements is achieved.

In this case, the evaluating portion is configured to output, as the result of evaluation, a log indicating the amount of change, identification data of the actuator for which the amount of change was measured, and the ranking of the amount of change.

Since the identification data (name, part number, etc.) of the actuator for which the amount of change was measured and the ranking of the amount of change are outputted in addition to the amount of change, it is possible for an operator to check the output to easily confirm the change of conditions of the manufacturing facility. As a result, even a small amount of change can be controlled so as to avoid occurrence of serious troubles in advance.

Preferably, the evaluating portion includes a log storage portion configured to store the log, and the evaluating portion is configured not to store the amount of change in the log storage portion when the amount of change is less than the threshold that is smallest.

Thus, the amounts of change are not stored in the log storage portion when they are less than the smallest threshold, so that the amount of data stored in the log storage portion is reduced.

Further, preferably, the amount-of-change measuring portion includes a temporary data storage portion configured to temporarily store the execution data obtained this time, and the amount-of-change measuring portion is configured to measure the amount of change of the temporarily stored execution data from the reference data.

In this way, the amount of change of the temporarily stored execution data that was measured this time from the reference data is measured. This reduces the amount of measurement by the execution data measuring portion. Also, as compared with cases where the amount of change of the execution data from the reference data is measured on a real-time basis without temporarily storing it, it is possible to reduce erroneous evaluation (erroneous measurement) due to shift in time (time lag) in communication.

In this case, when the execution data is newly obtained, the execution data of the last time that is stored in the temporary data storage portion may be moved to a reference data storage portion, and then the new execution data may be stored in the temporary data storage portion.

Among execution data, which contain large amounts of data, only the execution data measured this time and the execution data measured last time are stored in the data storage portions, so that the amount of data stored is reduced and the facility can be continuously monitored through the amount of change.

The reference data may be the execution data that was obtained last time, the operation plan data, or the execution data that was obtained at the time before last or earlier.

Then, the amount of change between the execution data obtained this time and stored temporarily and the execution data obtained last time makes it possible to measure the amount of change that has changed rapidly (continuous changes). The amount of change with respect to the operation plan data makes it possible to measure the amount of long-term change (changes over time), and comparison with the execution data obtained before last or earlier makes it possible to measure the amount of slow change (continuous and over-time changes).

A facility operation analysis program according to another aspect of the present invention is configured to cause a computer to function as a facility operation analysis device configured to analyze a result of execution obtained when operations of a plurality of actuators constituting a facility are executed based on operation plan data.

The facility operation analysis program causes the computer to function as:

an execution data measuring portion configured to obtain execution data when the operations of the plurality of actuators are executed;

an amount-of-change measuring portion configured to measure the amount of change of the obtained execution data from reference data; and

an evaluating portion configured to evaluate the measured amount of change and output a result of evaluation.

When the evaluating portion outputs the result of evaluation, the facility operation analysis program causes the evaluating portion to compare the measured amount of change with a threshold of the amount of change that is set within a normal range in which the facility is not stopped, and output the result of evaluation in which the measured amount of change is ranked.

According to the present invention, by causing the computer to execute the facility operation analysis program, it is possible to continuously monitor the facility within a normal range in which the facility is not stopped so as to suitably perform inspection and investigation of the facility, and it is also possible to continuously grasp the extent of change (the amount of change) of the actuators forming the facility. Furthermore, since the evaluation result is outputted in which the amount of change of each actuator is ranked according to the threshold, human time for judging significance of the change of each of the plurality of actuators is reduced and uniformity of the judgements is achieved.

According to the present invention, it is possible to continuously monitor the facility within a normal range in which the facility is not stopped so as to suitably perform inspection and investigation of the facility, and it is also possible to continuously grasp the extent of change (the amount of change) of the actuators forming the facility. Furthermore, since the evaluation result is outputted in which the amount of change of each actuator is ranked according to the threshold, human time for judging significance of the change of each of the plurality of actuators is reduced and uniformity of the judgements is achieved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a facility operation analysis device according to an embodiment;

FIG. 2A is a chart used to explain a setting file as an example, and FIG. 2B is a timing chart illustrating operation plan data based on the setting file;

FIG. 3 is a timing chart showing the operation plan data of FIG. 2B and the corresponding execution data displayed in a superimposed manner;

FIG. 4 is a flowchart illustrating a program that is executed mainly by an execution data measuring portion;

FIG. 5 is a flowchart illustrating processing similar to that described in the comparative example of JPA 2017-045141;

FIG. 6 is a flowchart illustrating a program that is executed by an amount-of-change measuring portion; and

FIG. 7 is a flowchart illustrating a program that is executed mainly by an evaluating portion.

### DESCRIPTION OF THE PREFERRED EMBODIMENTS

The facility operation analysis device according to the present invention will now be described in detail referring to the accompanying drawings in conjunction with preferred embodiments.

### [Configuration]

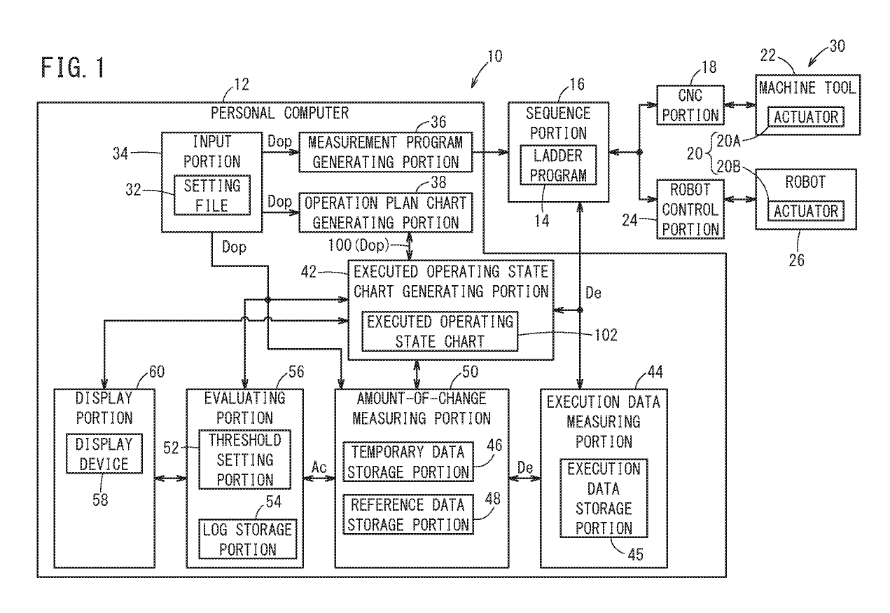

FIG. 1 is a schematic diagram illustrating the configuration of a facility operation analysis device 10 according to this embodiment.

The facility operation analysis device 10 basically includes a personal computer (PC) 12 as a control device for controlling the entirety of the facility operation analysis device 10, a sequence portion 16 configured to generate and store a ladder program 14 based on operation plan data, a CNC (computer numerical control) portion 18 configured to generate an NC (numerical control) program based on the ladder program 14 and the like, a machine tool 22 including a plurality of actuators 20A that operate according to the NC program from the CNC portion 18, a robot control portion 24 configured to generate a robot control program based on the ladder program 14 and the like, and a robot 26 including a plurality of actuators 20B that operate according to the robot control program from the robot control portion 24.

The machine tool 22 and the robot 26 constitute a manufacturing facility (facility) 30. The actuators 20A, 20B include a motor, solenoid, cylinder, etc., and the actuators 20A, 20B will be collectively referred to as actuators 20 for the purpose of avoiding being complicated.

The PC 12 includes a CPU (Central Processing Unit), a ROM (including EEPROM) and a RAM (Random Access Memory) as memory (a storage device), input/output devices such as A/D and D/A converters, timers as time counting devices, and so forth, and functions as various function realizing portions (function realizing means) including, for example, a control portion, operation portion, processing portion, etc., as the CPU reads and executes programs recorded in the ROM.

In this embodiment, the PC 12 includes an input portion 34 including a setting file 32, a measurement program generating portion 36, an operation plan chart generating portion 38, an executed operating state chart generating portion 42 configured to generate an executed operating state chart 102, an execution data measuring portion 44 including an execution data storage portion 45, an amount-of-change measuring portion 50 including a temporary data storage portion 46 and a reference data storage portion 48, an evaluating portion 56 including a threshold setting portion 52 and a log storage portion 54, and a display portion 60 including a display device 58.

The input portion 34 is capable of input of various signal information. At the input portion 34, various signal information constituting an operation plan (operation plan data) Dop for causing the actuators 20 of the manufacturing facility 30 to operate is inputted to the setting file 32 that is previously stored in a storage device of the PC 12. The various signal information is stored in a data file recorded in the storage device of the PC 12, for example. Specifically, the various signal information includes operating state of individual actuators 20, operating time, operation command address (command value address), operation check address (check value address), name, operating end name, operation check timer, preceding operation (previous operation), and following operation (next operation).

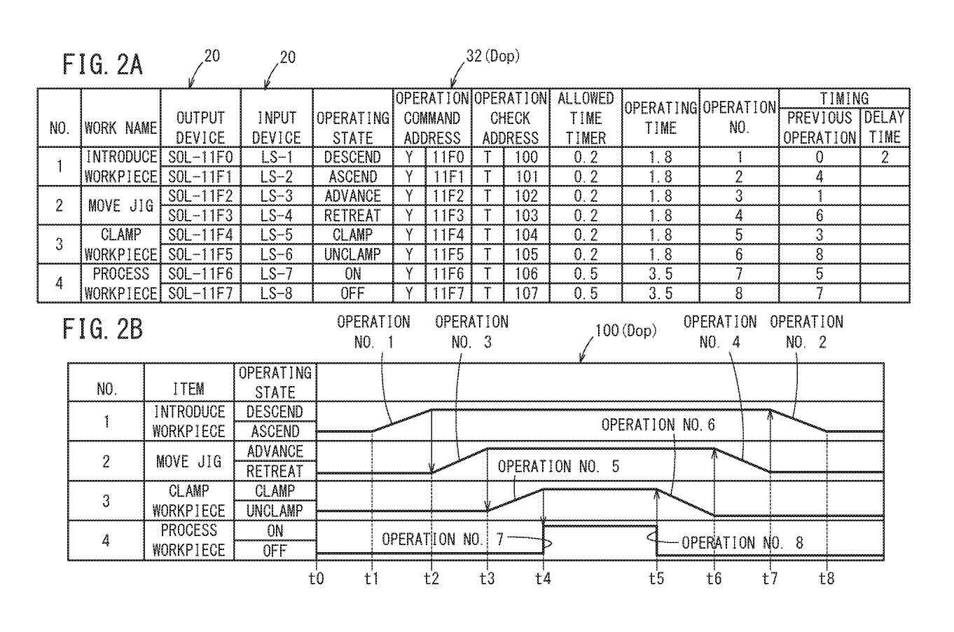

For example, as shown in FIG. 2A, the operation plan data Dop according to the setting file 32 is formed of a table showing the name of work by each actuator 20, the name of the output device such as solenoid “SOL-11F0”, the name of the input device such as limit switch “LS-1”, operating state of a workpiece jig etc., such as “descend”, that is based on the operation of the output device, operation command address (e.g., the address of holder Y like “11F0”), operation check address (e.g., “100” for holder T), allowed time preceding an operation check timer action (e.g., “0.2 second”), operating time of the output device (e.g., “1.8 seconds”), operation No., and timing (previous operation No. and delay time).

It is seen by referring to the columns of the operation No. and timing that the operations of the output devices according to the operation plan data Dop are in order of: operation No. 1 (previous operation No. 0)→operation No. 3 (previous operation No. 1)→operation No. 5 (previous operation No. 3)→operation No. 7 (previous operation No. 5)→operation No. 8 (previous operation No. 7)→operation No. 6 (previous operation No. 8)→operation No. 4 (previous operation No. 6)→operation No. 2 (previous operation No. 4).

The operation plan chart generating portion 38 generates the operation plan chart 100 based on the various signal information constituting the operation plan data Dop for each actuator 20 that is inputted at the input portion 34. In practice, on the basis of the setting file 32 to which the various signal information forming the operation plan data Dop was inputted at the input portion 34, the operation plan chart generating portion 38 reads the operating state and operating time of each actuator 20, and generates, based on the information, the operation plan chart 100 reflecting the driving time zone of each actuator 20.

The operation plan chart generating portion 38 reads the operating state, operating time, etc. of each actuator 20 based on the setting file 32 containing the operation plan data Dop and generates the operation plan chart 100 (FIG. 2B) that represents a timing chart reflecting the driving time zone of each actuator 20.

Now, the contents of the operation plan chart 100 (operation plan data Dop) shown in FIG. 2B will be described which is generated by the operation plan chart generating portion 38 based on the setting file 32 (operation plan data Dop) shown in FIG. 2A.

For example, at the manufacturing facility 30 such as an automated production line in a plant, a workpiece conveyed e.g., by a conveyor to a position in the space above a worktable (time t0, previous operation No. 0) is lowered from the spatial position taking 1.8 seconds by the operation No. 1 at time t1 after a wait time of 2 seconds, with the output device SOL-11F0 corresponding to actuator 20B of the robot 26. Then, when the input device LS-1 is activated in 0.2 second (operation check), then the workpiece is introduced and positioned on the worktable on the machine tool 22 (time t2).

Next, at time t2, by the operation No. 3 (previous operation No. 1), a jig is advanced by the output device SOL-11F2 corresponding to actuator 20B of the robot 26, taking a time of 2 seconds (1.8 seconds+0.2 second), followed by an operation check (time t3).

Next, at time t3, by the operation No. 5 (previous operation No. 3), the workpiece is clamped taking 2 seconds by the output device SOL-11F4 corresponding to actuator 20B of the robot 26, followed by an operation check (time t4).

Next, at time t4, by the operation No. 7 (previous operation No. 5), processing by a tool of the machine tool 22 to the workpiece being clamped by the jig is started by the output device SOL-11F6 corresponding to actuator 20A of the machine tool 22.

Next, between time t4 and time t5, the workpiece is processed by the tool for 4 seconds (3.5 seconds+0.5 second). Then, at time t5, by the operation No. 8 (previous operation No. 7), the processing of the workpiece by the tool is ended by the output device SOL-11F7.

After that, in short, the workpiece after processed is unclamped from the jig between time t5 and time t6 (operation No. 6 (previous operation No. 8)), the jig is retreated from the workpiece between time t6 and time t7 (operation No. 4 (previous operation No. 6)), and the workpiece is returned to the conveyor in the space above the worktable between time t7 and time t8 (operation No. 2 (previous operation No. 4)).

The measurement program generating portion 36 is configured to automatically generate a measurement program based on the setting file 32 to which the various signal information forming the operation plan was inputted at the input portion 34. The measurement program means a collection of information in the form of a program that is made based on the information of the setting file 32, about addresses where the actuators 20 and their signal values to be monitored during execution of the ladder program 14 are stored.

As has been explained referring to FIG. 2B, the operation plan chart 100 (operation plan data Dop) is formed of a timing chart generated based on the setting file 32.

The executed operating state chart generating portion 42 generates the executed operating state chart 102 based on the operating states of the actuators 20 (i.e., execution data De from the execution data measuring portion 44) during the execution at the manufacturing facility 30 of the ladder program 14 that is generated at the sequence portion 16 based on the various signal information that was inputted at the input portion 34 and that constitutes the operation plan data Dop.

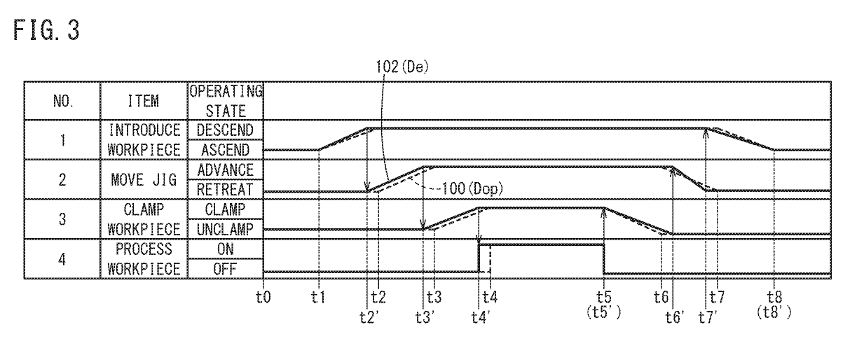

FIG. 3 shows a state (time chart) of superimposed display of the operation plan chart 100 indicated by dashed line (the time chart shown by solid line in FIG. 2B, which corresponds to the operation plan data Dop) and the executed operating state chart 102 indicated by solid line and corresponding to the execution data De.

For example, in the operation plan chart 100 (operation plan data Dop), the timing by which the forward movement of the jig is started corresponds to time t2. However, it is seen in the executed operating state chart 102 (execution data De) that the timing is somewhat moved up to time t2′.

Also, for example, in the operation plan chart 100 (operation plan data Dop), the workpiece is processed between time t4 and time t5. However, it is seen in the executed operating state chart 102 (execution data De) that the workpiece processing time is somewhat extended to the period between time t4′ and t5′ (t5).

The executed operating state chart 102 (execution data De) superimposed on the operation plan chart 100 (operation plan data Dop) can be displayed on the display device 58 of the display portion 60.

The sequence portion 16 contains the ladder program 14 for causing the actuators 20A, 20B of the machine tool 22 and the robot 26 to operate, and it executes the ladder program 14 through a given operation from the PC 12 or through a command signal from the CNC portion 18.

The CNC portion 18 reads its NC program generated from the ladder program 14, and executes the NC program through a given operation from the PC 12 so as to activate the actuators 20A to operate the machine tool 22.

The robot control portion 24 reads the robot control program generated from the ladder program 14 and activates the actuators 20B and controls the robot 26 so as to change the posture of the robot 26, adjust the arms of the robot 26, and so on. The robot 26 can move to arbitrary postures and can change its arms to arbitrary states through the control of the robot program.

While operations of the individual actuators 20 (actuators 20A, actuators 20B) are being executed through the sequence portion 16 and via the CNC portion 18 and robot control portion 24, the execution data measuring portion 44 monitors the operating states of the individual actuators 20 by using the measurement program generated by the measurement program generating portion 36, so as to obtain (measure) the execution data De (data corresponding to the executed operating state chart 102 described above). The execution data measuring portion 44 stores the execution data De thus obtained into the execution data storage portion 45 and also transmits the execution data De to the executed operating state chart generating portion 42 and to the amount-of-change measuring portion 50.

The amount-of-change measuring portion 50 measures (calculates) the amount of change Ac of the execution data De obtained at the execution data measuring portion 44 from reference data Dr (Ac=De−Dr).

The amount-of-change measuring portion 50 includes the temporary data storage portion 46 configured to temporarily store the execution data De measured this time or the like.

More specifically, while the execution data storage portion 45 stores the execution data De that was measured this time and the temporary data storage portion 46 stores the execution data De that was measured last time, they operate in a manner like so-called FIFO (First-In First-Out) memory, where, when new execution data De is obtained by the execution data measuring portion 44, the execution data De stored in the temporary data storage portion 46 is deleted, the execution data De currently stored in the execution data storage portion 45 is transferred and stored to the temporary data storage portion 46, and the new execution data De measured this time is stored in the execution data storage portion 45.

As will be described below, in this embodiment, the execution data De that was measured last time and stored in the temporary data storage portion 46 is stored (recorded) as the reference data Dr in the reference data storage portion 48.

As the reference data Dr, one of the execution data De measured last time, the operation plan data Dop, and the execution data De measured at the time before last or earlier is selectively stored in the reference data storage portion 48 of the amount-of-change measuring portion 50 by e.g., an operator of the PC 12, or through a facility operation analysis program.

The evaluating portion 56 evaluates the amount of change Ac by comparing the amount of change Ac measured at the amount-of-change measuring portion 50 with thresholds TH.

The threshold setting portion 52 of the evaluating portion 56 has set therein a plurality of thresholds TH for the amount of change Ac within a normal range in which the manufacturing facility (facility) 30 is not stopped.

Specifically, the manufacturing facility (facility) 30 is stopped when the cycle time has been reached and exceeded and a time error occurs, or when an output signal is not generated due to a fault of a sensor etc., and an interlock operates to cause a time error, and therefore the thresholds TH are set to values (time etc.) sufficiently preceding such a time error, for example.

More specifically, the evaluating portion 56 compares the thresholds TH set in the threshold setting portion 52 and the amount of change Ac sent from the amount-of-change measuring portion 50 and ranks the amount of change Ac. For example, the ranking includes: “abnormality diagnosed” that requires a review (readjustment) of settings (the amount of change Ac exceeds a largest threshold TH1 (Ac>TH1) and an abnormality is likely to occur and so a prompt diagnosis by an operator is required); “investigation required” (the amount of change Ac is not greater than the threshold TH1 but exceeds a next larger threshold TH2 (TH1 Ac>TH2) and an investigation by an operator is required in order to find the cause of the large amount of change Ac); and “follow-up required” (the amount of change Ac is not greater than the threshold TH2 but exceeds a smallest threshold TH3 (TH2≥Ac>TH3) and a follow-up by an operator is required). The evaluating portion 56 then outputs it to the display portion 60 together with identification data of the actuator 20 (the actuator name or actuator part number for uniquely identifying the actuator).

Then, the display portion 60 displays on the display device 58 the results of evaluation including the amount of change Ac, the identification data of the actuator 20 for which the amount of change Ac was measured, and the ranking of the amount of change Ac (“abnormality diagnosed”, “investigation required”, “follow-up required”). Data concerning a newly ranked amount of change Ac may be displayed in a pop-up manner.

The ranked amount of change Ac, the corresponding execution data De, and the identification data of the actuator 20 that has caused the amount of change Ac and the execution data De are stored in the log storage portion 54 of the evaluating portion 56 as an abnormality diagnosed log, an investigation required log, or a follow-up required log.

In this case, when the amount of change Ac is very small, the evaluating portion 56 may delete the amount of change Ac and corresponding execution data De without storing them in the log storage portion 54 in order to reduce the amount of data.

As stated earlier, the display portion 60 displays the results of evaluation (the ranked amount of change Ac, the identification data of the actuator 20, etc.) on the display device 58.

### [Operations]

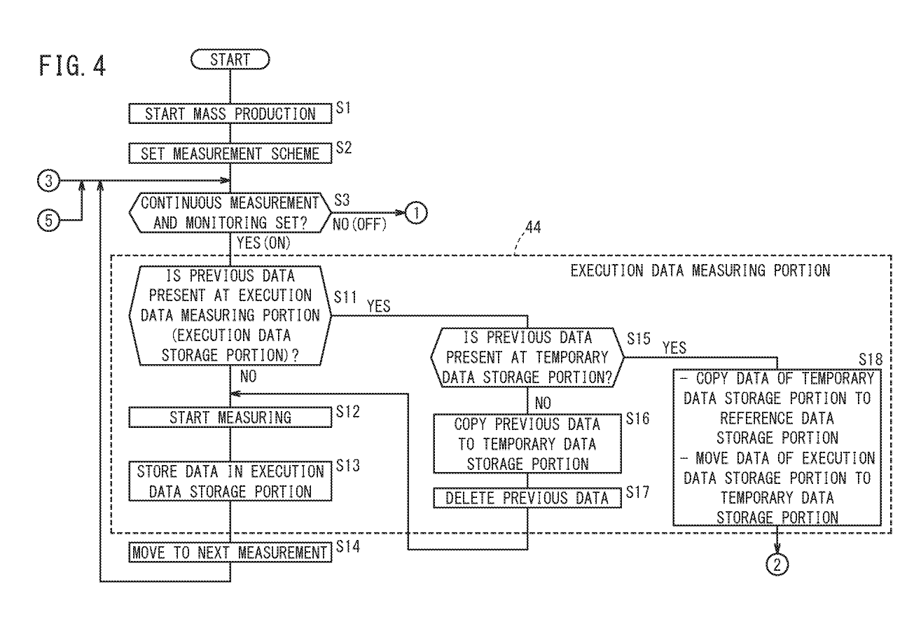

Operations of the facility operation analysis device 10 of this embodiment configured basically as described above will now be explained referring to the flowcharts of FIGS. 4 to 7.

At step S1, through an operation of the PC 12 by an operator, the ladder program 14, NC program, and robot program of this manufacturing facility 30 concerning the start of mass production of products this time are set and introduced in the sequence portion 16, CNC portion 18, and robot control portion 24, respectively, and then the manufacturing facility 30 is activated to start the mass production of products.

Next, at step S2, a scheme for the measurement of the actuators 20 is set on the PC 12. This measurement scheme includes setting of the kind of the data to be stored in the reference data storage portion 48, determination of the contents of setting of the amount of change Ac to be measured at the amount-of-change measuring portion 50, the thresholds TH set at the threshold setting portion 52 of the evaluating portion 56, and so on.

In this case, at the amount-of-change measuring portion 50, the reference data Dr is subtracted (subtraction) from the execution data De as the data measured this time so as to measure (calculate) the amount of change Ac. In this embodiment, it is assumed that the kind of the reference data Dr that is stored in the reference data storage portion 48 is set to be the execution data De that is the data measured at the previous time.

Items of the “setting” of the amount of change Ac includes a basic setting (solo operations of the actuators 20) and a combinational setting (combinational operations of the actuators 20).

The basic setting (solo operations of the actuators 20) enables analysis of “items to be analyzed” including rise time (operating time) and fall time (operating time), high-level operation interval and low-level operation interval, and the number of operations.

On the other hand, the combinational setting (combinational operations of the actuators 20) enables analysis of “items to be analyzed” including composite operating time of first and second actuators (the time from when the first actuator is activated to when the second actuator ends operating) and composite operation interval (the time from when the first actuator ends operating to when the second actuator starts operating).

When the setting of the measurement scheme of the actuators 20 has thus been finished at step S2 (the kind of the data to be stored in the reference data storage portion 48, the contents of setting of the amount of change Ac to be measured at the amount-of-change measuring portion 50, and the contents of the thresholds TH set in the threshold setting portion 52), then step S3 determines whether the setting has been made to perform continuous measurement and monitoring (continuous monitoring) by the execution data measuring portion 44.

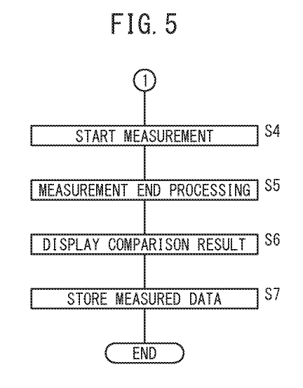

When the setting for continuous measurement and monitoring has not been made (Step S3: NO (continuous measurement and monitoring setting OFF)), the process proceeds to step S4 of FIG. 5 through connectors “1” and “1” on the flowcharts. The processing there is similar to that of JPA 2017-045141 and will hence be described only briefly here. The executed operating state chart generating portion 42 starts measurement and acquisition of the execution data De of this time by starting operations of the actuators 20 of the manufacturing facility 30 according to the measurement program generated based on the operation plan (operation plan data Dop). At step S5, the operations of the actuators 20 of the manufacturing facility 30 are ended and the measurement and acquisition of the execution data De of this time are then ended.

Next, at step S6, the operation plan chart 100 corresponding to the operation plan data Dop and the executed operating state chart 102 corresponding to the execution data De are displayed in a superimposed manner (see FIG. 3), and then at step S7, the execution data De of this time is stored in the executed operating state chart generating portion 42 as the measured data, and the processing is terminated.

On the other hand, when the setting for continuous monitoring has been made (step S3: YES (continuous measurement and monitoring setting ON)), then at step S11 of FIG. 4, the execution data measuring portion 44 determines whether the previous execution data (previous data) is stored in the execution data storage portion 45 of the execution data measuring portion 44. When the previous data is not stored (step S11: NO), the measurement concerning the production of this time is started and executed at step S12, where the machine tool 22 (actuators 20A) and the robot 26 (actuators 20B) of the manufacturing facility 30 are operated through the sequence portion 16, CNC portion 18, and robot control portion 24, according to the measurement program generated based on the operation plan data Dop, under a control of the execution data measuring portion 44.

Then, at step S13, the execution data De, as the actual operation data of the actuators 20 (20A, 20B) of the manufacturing facility 30, is stored in the execution data storage portion 45 of the execution data measuring portion 44 through the CNC portion 18, robot control portion 24, and sequence portion 16.

That is, at step S13, the actuators 20A of the machine tool 22 are operated from the execution data measuring portion 44 via the sequence portion 16 and through the CNC portion 18, according to the NC program concerning the ladder program 14 corresponding to the measurement program based on the operation plan data Dop, and the execution data De obtained as the results of operation is captured into the execution data storage portion 45. At the same time, at step S13, the actuators 20B of the robot 26 are operated from the execution data measuring portion 44 via the sequence portion 16 and through the robot control portion 24, according to the robot control program concerning the ladder program 14 corresponding to the measurement program based on the operation plan data Dop, and the execution data De obtained as the results of operation is captured into the execution data storage portion 45 (the data is stored).

Next, the process moves to the next measurement at step S14, and the determination of step S3 is made again.

In this case, the process proceeds as step S3: YES, step S11: YES, and then it is determined at step S15 whether the previous execution data (previous data) is stored in the temporary data storage portion 46 of the amount-of-change measuring portion 50. If the previous data is absent (step S15: NO), then, at step S16, the execution data De stored in the execution data storage portion 45 is copied to the temporary data storage portion 46 as the previous data, and then at step S17, the execution data De stored as the previous data in the execution data storage portion 45 is deleted.

After such data transfer processing, further measurement is started at step S12, the new execution data De of the measurement of this time is stored in the execution data storage portion 45 at step S13, and the process moves to the next measurement at step S14.

Next, through step S3: YES→step S11: YES→step S15: YES, then at step S18, the execution data De of the last time stored in the temporary data storage portion 46 is copied as the reference data Dr to the reference data storage portion 48, and then the execution data De of this time stored in the execution data storage portion 45 is moved to the temporary data storage portion 46 (the previous data that was stored in the execution data storage portion 45 has been deleted and does not exist now).

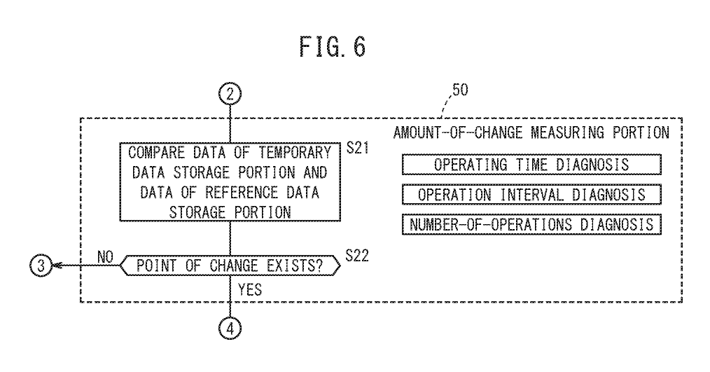

Next, the process proceeds through connectors “2” and “2” on the flowcharts, and then at step S21 of FIG. 6, the amount-of-change measuring portion 50 compares the execution data De of this time that is stored in the temporary data storage portion 46 with the execution data De of the last time that is stored in the reference data storage portion 48 (subtracts the execution data De of the last time from the execution data De of this time) to thereby obtain the difference as the amount of change Ac.

Now, in this embodiment, the amount of change Ac includes the amounts of change Ac concerning an operating time diagnosis, the amounts of change Ac concerning an operation interval diagnosis, and the amounts of change Ac concerning a number-of-times diagnosis, of the basic setting.

If the determination of step S22 indicates that the amount of change Ac is not greater than the smallest threshold TH3, it is determined that there was no point of change (step S22: NO) and the process moves to step S3 of FIG. 4 through connectors “3” and “3” on the flowcharts.

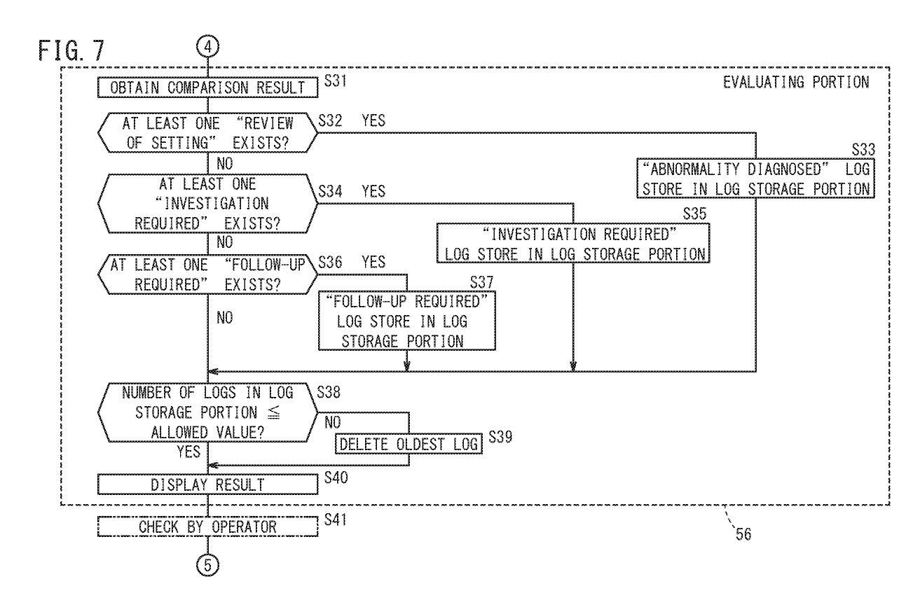

On the other hand, if the determination of step S22 indicates that there is an amount of change Ac that exceeds the smallest threshold TH3 set within a normal range where the manufacturing facility 30 is not stopped and that can hence be recognized as the amount of change (point of change) Ac (step S22: YES), the process moves to step S31 of FIG. 7 through connectors “4” and “4” on the flowcharts, where the evaluating portion 56 obtains the amount of change Ac, which was recognized as a point of change, as the result of comparison.

Then, concerning the amounts of change Ac thus obtained, the evaluating portion 56 ranks the significant amounts of change Ac, where step S32 determines whether there is at least one amount of change Ac that is evaluated as “abnormality diagnosed” (Ac>TH1) and that hence requires a review of settings, step S34 determines whether there is at least one amount of change Ac that is not evaluated as “Ac>TH1” (step S32: NO) but that is evaluated as “investigation required” (TH1≥Ac>TH2), and step S36 determines whether there is at least one amount of change Ac that is not evaluated as “TH1≥Ac>TH2” (step S34: NO) but that is evaluated as “follow-up required” (TH2≥Ac>TH3). If the amount of change Ac is not greater than the threshold TH3 (step S36: NO), it is stored in the log storage portion 54 as a slight, less significant amount of change Ac not requiring being ranked, and the process moves to step S38.

If the determination of step S32 is positive (step S32: YES), then at step S33, the evaluating portion 56 stores that amount of change Ac (Ac>TH1) and the identification data concerning that amount of change Ac as an abnormality diagnosed log in the log storage portion 54. If the determination of step S34 is positive (step S34: YES), then at step S35, the evaluating portion 56 stores that amount of change Ac (TH1≥Ac>TH2) and the identification data concerning that amount of change Ac as an investigation required log in the log storage portion 54. If the determination of step S36 is positive (step S36: YES), then at step S37, the evaluating portion 56 stores that amount of change Ac (TH2≥Ac>TH3) and the identification data concerning that amount of change Ac as a follow-up required log in the log storage portion 54. Then the process moves to step S38.

At step S38, the evaluating portion 56 determines whether the number of logs stored in the log storage portion 54 is equal to or less than an allowed value (i.e., whether the number of logs the allowed value). When the number of logs is equal to or less than the allowed value (step S38: YES), and when the number of logs exceeds the allowed value (step S38: NO), where the oldest log is deleted at step S39, the results of diagnosis that were ranked this time are sent to the display portion 60 in either case.

At step S40, the display portion 60 displays the results of diagnosis ranked this time on the display device 58. In this case, the contents indicating the results of diagnosis are checked at step S41 not by computer processing but in offline processing by an operator and a maintenance work corresponding to the ranking is performed.

After the processing of step S40, the process moves to step S3 through connector “5” on the flowchart of FIG. 7 and connector “5” on the flowchart of FIG. 4.

After that, in the same way, the steps are repeated as: step S3: YES→step S11: YES→step S15: YES→step S18→step S21→step S22 (→step S3)→step S31, . . . step S40→step S3.

### SUMMARY

As has been described so far, the facility operation analysis device 10 according to the embodiment analyzes the results of execution (execution data De) obtained when operations of the plurality of actuators 20 (20A, 20B) constituting the manufacturing facility 30 are executed according to the measurement program based on the operation plan data Dop.

For this purpose, the facility operation analysis device 10 includes: the execution data measuring portion 44 configured to obtain execution data De when the operations of the plurality of actuators 20 are executed; the amount-of-change measuring portion 50 configured to measure an amount of change Ac of the obtained execution data De from the reference data Dr; the evaluating portion 56 configured to evaluate the measured amount of change Ac and output the result of evaluation; and the display portion 60 configured to display the result of evaluation (“review of settings”, “investigation required”, or “follow-up required”, and “no problem” when necessary).

In this case, when the evaluating portion 56 outputs the result of evaluation to the display portion 60 to cause the display device 58 to display the result of evaluation, the evaluating portion 56 compares the measured amount of change Ac with the thresholds TH1 to TH3 (TH1>TH2>TH3) of the amount of change Ac that are set for each of the plurality of actuators 20 within a normal range where the manufacturing facility 30 is not stopped, thereby obtaining the result of evaluation in which the measured amount of change Ac is ranked according to the thresholds TH1 to TH3 (“abnormality diagnosed” (the amount of change Ac exceeds the largest threshold TH1 (Ac>TH1) and an abnormality is likely to occur and so a prompt diagnosis by an operator is required); “investigation required” (the amount of change Ac is not greater than the threshold TH1 but exceeds the next larger threshold TH2 (TH1≥Ac>TH2) and an investigation by an operator is required in order to find the cause of the large amount of change Ac); and “follow-up required” (the amount of change Ac is not greater than the threshold TH2 but exceeds the smallest threshold TH3 (TH2≥Ac>TH3) and a follow-up by an operator is required). Then, the evaluating portion 56 outputs it to the display portion 60 together with identification data of the actuator 20 (the name or part number of the actuator for uniquely identifying the actuator).

At this time, the display portion 60 causes the display device 58 to display as the result of evaluation, the amount of change Ac, the identification data of the actuator 20 for which the amount of change Ac was measured, and the ranking of the amount of change Ac (“abnormality diagnosed”, “investigation required”, and “follow-up required”).

In this way, it is possible to continuously monitor the manufacturing facility 30 within a normal range in which the manufacturing facility 30 is not stopped so as to suitably perform inspection and investigation of the manufacturing facility 30, and it is also possible to continuously grasp the extent of change (the amount of change Ac over time) of the actuators 20 forming the manufacturing facility 30. Furthermore, since the evaluation result is outputted in which the amount of change Ac of each actuator 20 is ranked according to the thresholds TH1 to TH3, human time for judging significance of the change of each actuator 20 is reduced and uniformity of the judgements is achieved.

The evaluating portion 56 causes the display device 58 to display, as the results of the evaluation, a log indicating the amount of change Ac, the identification data (name, part number, etc.) of the actuator 20 for which the amount of change Ac was measured, and the ranking of the amount of change Ac. This allows an operator to check the display to easily grasp variation of conditions of the manufacturing facility 30. As a result, even a small amount of change Ac can be controlled so as to avoid occurrence of serious troubles in advance.

Further, while the evaluating portion 56 includes the log storage portion 54 for storing the logs, the amount of change Ac that is less than the smallest threshold TH3 is not stored in the log storage portion 54. This reduces the amount of data stored in the log storage portion 54.

Further, the amount-of-change measuring portion 50 includes the temporary data storage portion 46 for temporarily storing the execution data De obtained this time, and measures the amount of change Ac of the temporarily stored execution data De from the reference data Dr (Ac=De−Dr). This reduces the amount of measurement by the execution data measuring portion 44. Also, as compared with conventional cases where the amount of change Ac of the execution data De from the reference data Dr is measured on a real time basis without temporarily storing it, it is possible to reduce erroneous evaluation (erroneous measurement) due to shift in time (time lag) in communication.

The amount of change Ac may be obtained as a ratio of the execution data De to the reference data Dr (Ac=De/Dr).

As to the temporary data storage portion 46, when execution data De is newly obtained, the execution data De of the last time that is stored in the temporary data storage portion 46 is moved to the reference data storage portion 48, and then the new execution data De is stored in the temporary data storage portion 46. This reduces the amount of stored data and allows the manufacturing facility 30 to be continuously monitored through the amount of change Ac.

In this case, the reference data Dr is not limited to the execution data De that was obtained last time, but it may be the operation plan data Dop, or the execution data De that was obtained at the time before last or earlier. Then, the amount of change Ac between the execution data De obtained this time and stored temporarily and the execution data De obtained last time makes it possible to measure (monitor) the amount of change that has changed rapidly (continuous changes). The amount of change Ac between the execution data De obtained this time and stored temporarily and the operation plan data Dop makes it possible to measure (monitor) the amount of long-term change (changes over time), and the comparison between the execution data De obtained this time and stored temporarily and the execution data De obtained before last or earlier makes it possible to measure (monitor) the amount of slow change (continuous and over-time changes).

A facility operation analysis program according to this embodiment is configured to cause a computer (PC 12) to function as a facility operation analysis device 10 configured to analyze a result of execution obtained when operations of a plurality of actuators 20 (20A, 20B) constituting the manufacturing facility 30 are executed based on the operation plan data Dop. The facility operation analysis program causes the computer (PC 12) to function as: the execution data measuring portion 44 configured to obtain execution data De when the operations of the plurality of actuators 20 are executed (steps S11 to S13, S15 to S18 of FIG. 4); the amount-of-change measuring portion 50 configured to measure the amount of change Ac of the obtained execution data De from the reference data Dr (steps S21, S22 of FIG. 6); and the evaluating portion 56 configured to evaluate the amount of change Ac and output the result of evaluation (steps S31 to S40 of FIG. 7).

Further, when the evaluating portion 56 outputs the result of evaluation to the display portion 60 to cause the display portion 60 (the display device 58 thereof) to display the result of evaluation, the computer is caused to function to compare the measured amount of change Ac with the thresholds TH1 to TH3 of the amount of change Ac that are set within a normal range in which the manufacturing facility 30 is not stopped, and display the result of evaluation in which the measured amount of change Ac is ranked.

In this way, by causing the PC 12 being a computer to execute the above-described program, it is possible to continuously monitor the manufacturing facility 30 within a normal range in which the manufacturing facility 30 is not stopped so as to suitably perform inspection and investigation of the facility, and it is also possible to continuously grasp the extent of change (the amount of change Ac) of the actuators 20 forming the manufacturing facility 30. Furthermore, since the evaluation result is outputted in which the amount of change Ac of each actuator 20 is ranked according to the thresholds TH1 to TH3, human time for judging significance of the change of each of the plurality of actuators 20 is reduced and uniformity of the judgements is achieved.

The present invention is not limited to the above-described embodiment and can of course employ various configurations based on the description of this specification.

What is claimed is:

1. A facility operation analysis device configured to analyze a result of execution obtained when operations of a plurality of actuators constituting a facility are executed based on operation plan data, comprising:
an execution data measuring portion configured to obtain execution data when the operations of the plurality of actuators are executed;
an amount-of-change measuring portion configured to measure an amount of change of the obtained execution data from reference data; and
an evaluating portion configured to evaluate the measured amount of change and output a result of evaluation,
wherein when the evaluating portion outputs the result of evaluation, the evaluating portion compares the measured amount of change with a threshold of the amount of change that is set for each of the plurality of actuators within a normal range in which the facility is not stopped, and outputs the result of evaluation in which the measured amount of change is ranked.

2. The facility operation analysis device according to claim 1, wherein the evaluating portion is configured to output, as the result of evaluation, a log indicating the amount of change, identification data of the actuator for which the amount of change was measured, and the ranking of the amount of change.

3. The facility operation analysis device according to claim 2, wherein the evaluating portion includes a log storage portion configured to store the log, and
the evaluating portion is configured not to store the amount of change in the log storage portion when the amount of change is less than the threshold that is smallest.

4. The facility operation analysis device according to claim 1, wherein the amount-of-change measuring portion includes a temporary data storage portion configured to temporarily store the execution data obtained this time, and
the amount-of-change measuring portion is configured to measure the amount of change of the temporarily stored execution data from the reference data.

5. The facility operation analysis device according to claim 4, wherein, when the execution data is newly obtained, the execution data of last time that is stored in the temporary data storage portion is moved to a reference data storage portion, and then the newly-obtained execution data is stored in the temporary data storage portion.

6. The facility operation analysis device according to claim 4, wherein the reference data is the execution data that was obtained last time, the operation plan data, or the execution data that was obtained at a time before last or earlier.
